(19) United States
(12) Patent Application Publication
(10) Pub. No.: US 2020/0028298 A1
(43) Pub. Date: Jan. 23, 2020

(54) CONNECTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Shuya Nishio, Yokkaichi, Mie (JP); Junichi Mukuno, Yokkaichi, Mie (JP)

(21) Appl. No.: 16/495,418

(22) PCT Filed: Mar. 14, 2018
(86) PCT No.: PCT/JP2018/009866

§ 371 Date: Sep. 19, 2019

(30) Foreign Application Priority Data
Mar. 27, 2017 (JP) 2017-060639

(51) Int. Cl. H01R 13/533

(52) U.S. Cl. CPC H01R 13/533; H01R 2201/26

(57) ABSTRACT

A connector 1 includes a connector housing 50 connectable to a mating connector, female terminals 11 and L-shaped terminals 21 accommodated inside the connector housing 50 and made of a conductive material, and braided wires 31 connecting the female terminals 11 and the L-shaped terminals 21. The braided wire 31 is formed by braiding a plurality of strands 32, 33. The plurality of strands 32, 33 include conductor strands 32 made of a conductive material and high attenuation strands 33 made of a high damping material. The high damping material is a rubber, a resin or a high damping metal. The high damping metal is a damping alloy or a steel material.

### BACKGROUND

### Field of the Invention

This specification relates to a connector.

### Related Art

Japanese Unexamined Patent Publication No. 2010-225488 discloses a connector that includes a first terminal to be connected to a mating terminal in a mating connector, a second terminal to be connected to a device, and a coupling portion coupling these two terminals. The coupling portion is constituted by a braided wire. The braided wire is a flexible tubular or sheet-like member formed by braiding metal strands. According to this configuration, a displacement of each member due to thermal expansion caused by heat generation associated with a thermal environment or energization can be absorbed by the braided wire.

In the connector configured as described above, the braided wire may resonate if vibration is applied from outside. If the braided wire resonates, the terminal in the connector and the mating terminal may slide against each other to cause troubles such as the wear of the terminals.

### SUMMARY

A connector disclosed by this specification includes a connector housing that is connectable to a mating connector. A first conductive member and a second conductive member are accommodated inside the connector housing and are made of a conductive material. A braided wire is formed by braiding a plurality of strands and connects the first conductive member and the second conductive member. The strands of the braided wire include conductor strands made of a conductive material and high attenuation strands made of a high damping material. The high damping material may be a rubber, a resin or a high damping metal. The high damping metal may be a damping alloy or a steel material. According to this configuration, an amplification ratio when the braided wire resonates can be reduced as compared to the case where a conventional braided wire is used, and troubles caused by the resonance of the braided wire can be reduced.

In the above configuration, the connector may be connected to a device installed in a vehicle. The connector may be connected to a device susceptible to vibration.

According to the connector disclosed by this specification, troubles caused by the resonance of the braided wire can be reduced.

### BRIEF DESCRIPTION OF DRAWINGS

FIG. 1 is a perspective view of a connector of an embodiment.

FIG. 2 is a side view of the connector of the embodiment.

FIG. 3 is a section along A-A of FIG. 2.

FIG. 4 is a section along B-B of FIG. 2.

FIG. 5 is a partial enlarged view of a braided wire.

### DETAILED DESCRIPTION

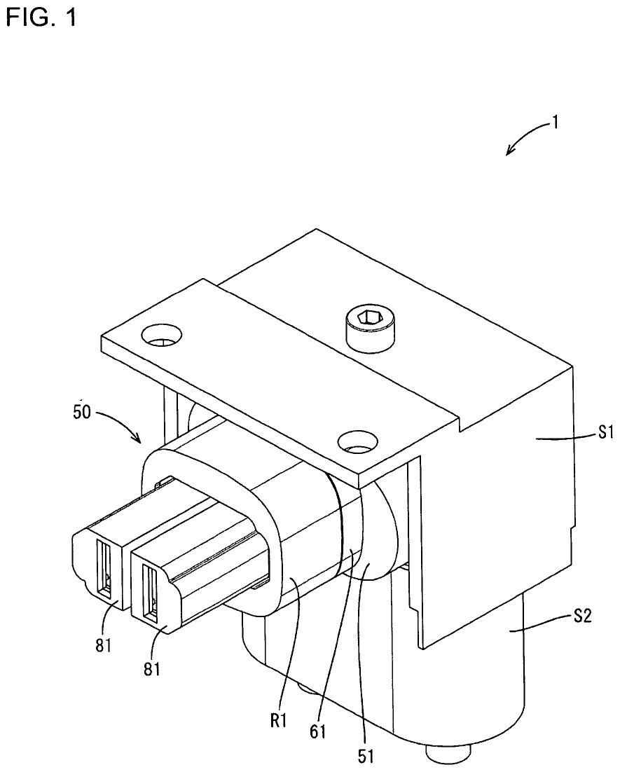

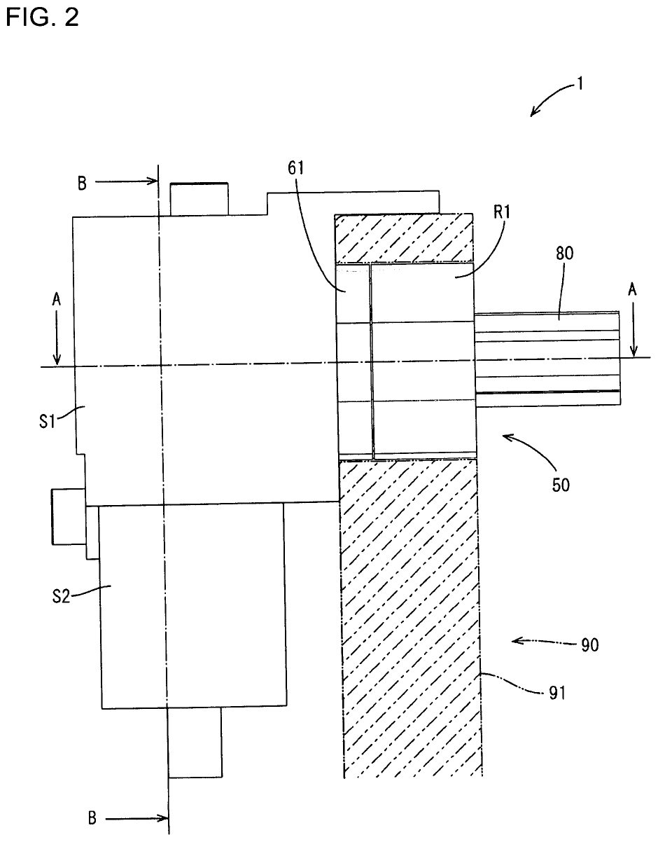

An embodiment is described with reference to FIGS. 1 to 5. A connector 1 of this embodiment is a shield connector to be mounted on a case 91 of a device 90 (inverter or motor) installed in a vehicle, such as a hybrid or electric vehicle.

The connector 1 includes a connector housing 50 made of synthetic resin, two inner conductive members 10, two terminal-equipped wires 40 and a terminal holding member 80 to be assembled with the connector housing 50. A first shield shell S1 and a second shield shell S2 are mounted to cover the connector housing 50.

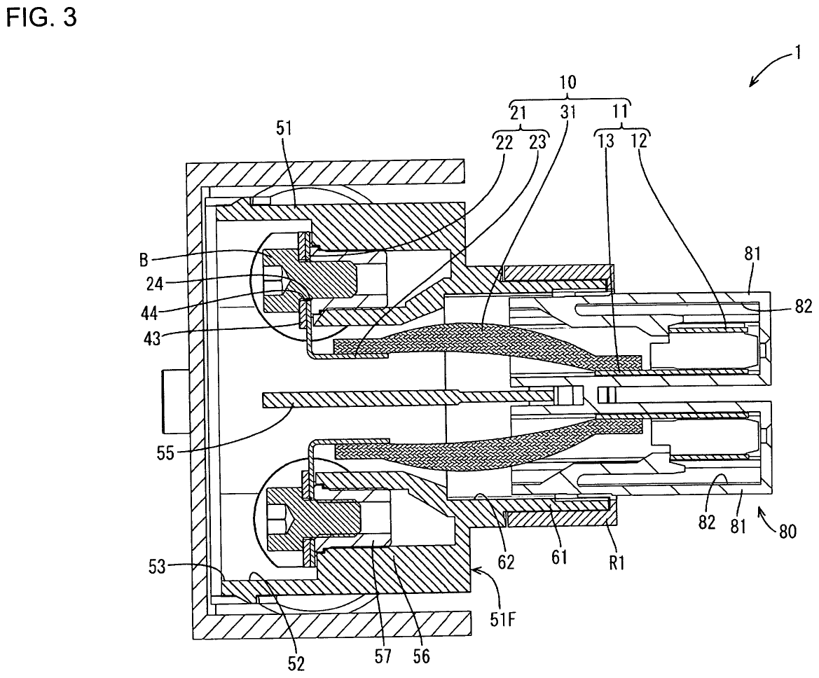

As shown in FIG. 3, the inner conductive member 10 is composed of a female terminal 11 (corresponding to a first conductive member) and an L-shaped terminal 21 (corresponding to a second conductive member) made of metal and a braided wire 31 connecting the female terminal 11 and the L-shaped terminal 21.

The female terminal 11 is to be connected to a mating terminal (not shown) arranged inside the case 91 and includes, as shown in FIG. 3, a terminal body 12 in the form of a rectangular tube and a first mounting portion 13 in the form of a plate extending from one end of the terminal body 12.

The L-shaped terminal 21 is a metal plate member bent into an L shape. As shown in FIG. 3, one side of the L shape serves as a fastening portion 22 including a bolt insertion hole 24 and the other side serves as a second mounting portion 23.

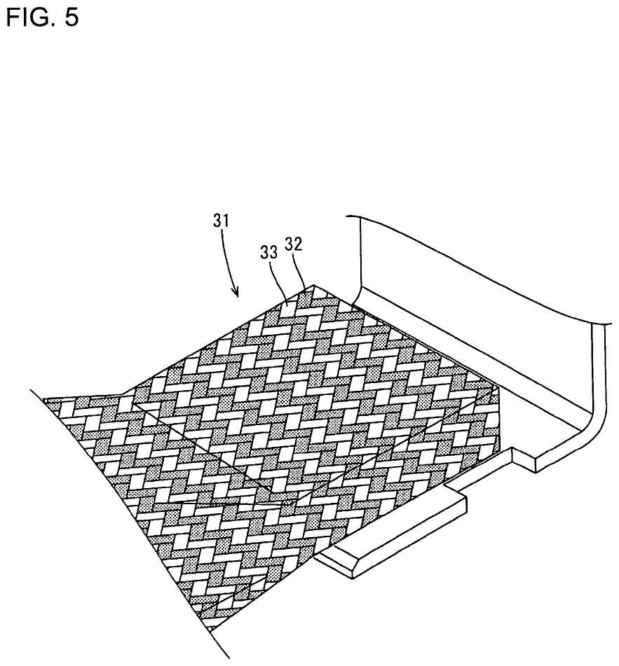

As shown in FIGS. 3 and 5, the braided wire 31 is a tubular member formed by braiding conductor strands 32 and high attenuation strands 33 into a mesh so that the braided wire is flexible and conductive. One end part of the braided wire 31 is overlapped on the first mounting portion 13 and is fixed by resistance welding. Further, the other end part is overlapped on the second mounting portion 23 and is fixed by resistance welding.

The conductor strands 32 are made of a conductive material, and the high attenuation strands 33 are made of a high damping material having a high vibration damping capacity. Examples of the high damping material include rubbers, resins and high damping metals.

The “vibration damping capacity” is an ability to absorb vibration by converting vibrational energy into thermal energy. The vibration damping capacity decreases in the order of “rubber materials>resin materials>metal materials”. The vibration damping capacity of the metal material decreases in the order of “damping alloys>steel materials not classified as damping metals>non-ferrous metals not classified as damping alloys”, and damping alloys and steel materials are classified as high damping metals. The damping alloys are classified into four types, i.e. twin crystal type, dislocation type, ferromagnetic type and composite type. Examples of the composite type damping alloy include flake graphite cast iron (Fe—C—Si based) and Cosmal-Z (Al—Zn based). Examples of the ferromagnetic type damping alloy include TD nickel (Ni based), 13% chromium copper (Fe—Cr based), silentalloy (Fe—Cr—Al based), trunkalloy (Fe—Cr—Al—Mn based), gentalloy (Fe—Cr—Mo based) and NIVC10 (Co—Ni based). Examples of the dislocation type damping alloy include KIXI alloy (Mn—Zr based). Examples of the twin crystal type damping alloy include sonostone (Mn—Cu based), incramute (Cu—Mn—Al based) and Nitinol (Ni—Ti based).

The conductor strands 32 are made of a conductive material, such as a metal. In consideration of conductivity, the conductor strands 32 desirably are made of a metal having a high conductivity, such as copper, copper alloy, aluminum or aluminum alloy and generally are used in wires or other conductive members.

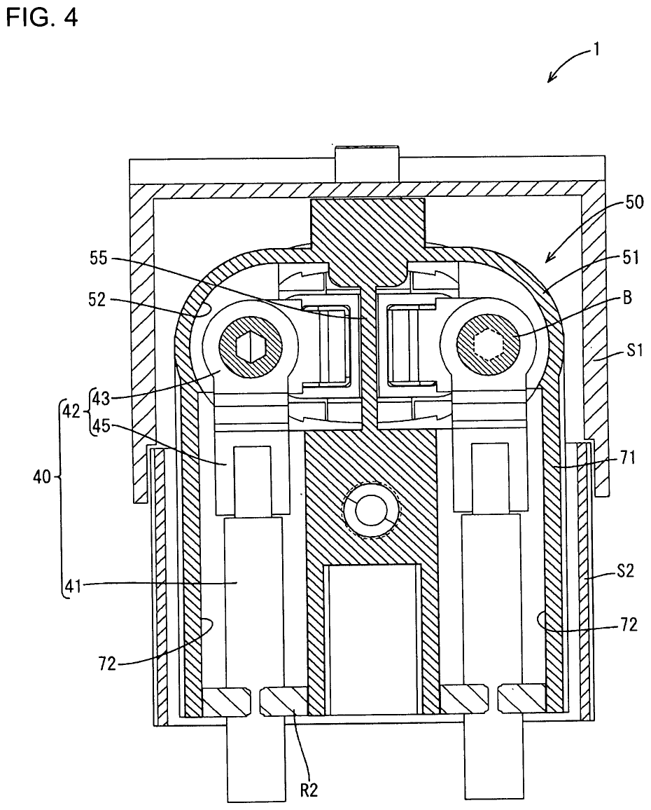

As shown in FIG. 4, the terminal-equipped wire 40 includes a wire 41 and a relay terminal 42 connected to one end part of the wire 41. Although not shown in detail, the wire 41 has a conductive core and an insulation coating covering around the core. The insulation coating is stripped at an end of the wire 41 to expose the core. The relay terminal 42 is made of metal and includes a plate-like connecting portion 43 having a bolt insertion hole 44. A barrel portion 45 is continuous from the connecting portion 43 and is to be crimped to the core exposed at the end of the wire 41. Note that the barrel portion 45 is shown in a simplified manner in FIG. 4.

The connector housing 50 includes a housing body 51, a fitting 61 continuous from the housing body 51 and a wire holding portion 71 continuous from the housing body 51.

The housing body 51 is a block-like part and, as shown in FIG. 3, outer surfaces of the housing body 51 include a connection surface 51F facing toward the case 91 when the housing body 51 is assembled with the device 90. As shown in FIG. 3, the housing body 51 includes an accommodation space 52 for accommodating parts of the inner conductive members 10 (parts of the braided wires 31 and L-shaped terminals 21). A work opening 53 is open in another surface of the housing body 51 parallel to the connection surface 51 and is used by a worker to insert his/her hand into the accommodation space 52 when mounting the inner conductive members 10 and the terminal-equipped wires 40 into the connector housing 50.

As shown in FIGS. 1 and 3, the fitting 61 is a tubular part extending from the connection surface 51F of the housing body 51 and is fittable to the mating connector (not shown) arranged inside the case 91. As shown in FIG. 3, an internal space of the fitting 61 serves as a mounting chamber 62 capable of accommodating the terminal holding member 80 and communicates with the accommodation space 52. The accommodation space 52 and the mounting chamber 62 are divided into two sections by a partition 55. A nut holding portion 56 is arranged inside each section, and a nut 57 is held in this nut holding portion 56.

The wire holding portion 71 is an elliptical tubular part extending from the housing body 51 in a direction perpendicular to the fitting 61 and includes, as shown in FIG. 4, two first cavities 72 for accommodating the terminal-equipped wires 40 inside. Each first cavity 72 communicates with the accommodation space 52 and is open in a surface opposite to the housing body 51.

The terminal holding member 80 is to be mounted into the fitting portion 61 and, as shown in FIG. 1, is shaped such that two tubular terminal accommodation tubes 81 are arranged side by side and coupled to each other. Internal spaces of the respective terminal accommodation tubes 81 serve as second cavities 82 for accommodating the female terminals 11, as shown in FIG. 3. This terminal holding member 80 is held in the fitting 61 with one end part accommodated in the mounting chamber 62 and the remaining part projecting out, as shown in FIG. 3, and retained by a first retainer R1 mounted on the tip of the fitting 61.

The first shield shell S1 is made of metal and, as shown in FIG. 1, is in the form of a rectangular box having openings in two surfaces. This first shield shell S1 is arranged to cover most of the housing body 51, assembled with the housing body 51 by bolt tightening and, when the connector 1 is mounted on the device 90, is fixed to the case 91 by bolt tightening.

As shown in FIGS. 1 and 4, the second shield shell S2 is a tubular member made of metal and mounted to cover the outer periphery of the wire holding portion 71.

Each inner conductive member 10 is accommodated as follows. As shown in FIG. 3, the female terminal 11 and a part of the braided wire 31 fixed to this female terminal 11 are accommodated in the second cavity 82, and the remaining part of the braided wire 31 and the L-shaped terminal 21 are accommodated inside the mounting chamber 62 and the accommodation space 52.

As shown in FIG. 4, the wire 41 and the barrel 45 of each terminal-equipped wire 40 are accommodated inside the first cavity 72. Further, a second retainer R2 is mounted in an opening of the first cavity 72 so that the wire 41 is retained. The connecting portion 43 is accommodated inside the accommodation space 52.

As shown in FIG. 3, the fastening portion 22 and the connecting portion 43 are overlapped to align the positions of the bolt insertion holes 24, 44 thereof, and are fixed by inserting a bolt B through the bolt insertion holes 24, 44 and screwing the bolt B into the nut 57. In this way, the inner conductive member 10 and the terminal-equipped wire 40 are connected electrically.

As described above, in the connector 1 using the flexible braided wires 31 in the inner conductive members 10, a displacement of each member due to thermal expansion caused by heat generation associated with a thermal environment or energization can be absorbed by the braided wires 31.

On the other hand, a braided wire generally has a natural frequency near 250 Hz and may resonate due to vibration during the travel of an automotive vehicle. If the braided wire resonates, a terminal provided in a connector and a mating terminal may slide against each other to cause troubles, such as the wear of the terminals.

Accordingly, in this embodiment, the braided wire 31 is formed by braiding the conductor strands 32 and the high attenuation strands 33. A resin material has a greater function of damping vibrational energy than a metal material. By braiding the high attenuation strands 33 together with the conductor strands 32 into the braided wire 31, an amplification ratio when the braided wire 31 resonates can be reduced.

As described above, according to this embodiment, the connector 1 includes the connector housing 50 connectable to the mating connector, the female terminal 11 and the L-shaped terminals 21 made of the conductive material and accommodated inside the connector housing 50, and the braided wires 31 connecting the female terminals 11 and the L-shaped terminals 21. The braided wire 31 is formed by braiding the conductor strands 32 made of the conductive material and the high attenuation strands 33 made of the high damping material. The high damping material is a rubber, a resin or a high damping metal, and the high damping metal is damping alloy or a steel material.

According to this configuration, the amplification ratio when the braided wire 31 resonates can be reduced as compared to the case where a conventional braided wire is used, and troubles caused by the resonance of the braided wire 31 can be reduced.

Further, the connector 1 is connected to the device 90 installed in the vehicle. The above-described connector 1 is suitable as a connector to be connected to the device 90 susceptible to vibration.

The invention is not limited to the above described and illustrated embodiment. For example, the following various modes are also included.

Although the connector 1 includes two inner conductive members 10 in the above embodiment, the numbers of the first conductive members, the second conductive members and the braided wires are not limited to those of the above embodiment and can be freely set according to the use and the like of the connector.

Although the first conductive member is the female terminal 11 to be connected to the mating terminal and the second conductive member is the L-shaped terminal 21 in the above embodiment, the configurations of the first conductive member and the second conductive member are not limited to those of the above embodiment. For example, the first conductive member may be a male terminal to be connected to a mating terminal. Alternatively, the second conductive member may be directly connected to the core of the wire without via the relay terminal.

Since the high damping metal is conductive, it can be also used as a material of the conductor strands. Specifically, both the conductor strands and the high attenuation strands may be made of high damping metals. In this case, the conductor strands and the high attenuation strands may be made of the same type of high damping metals or may be made of different types of high damping metals. Further, the high attenuation strands may be made of rubber or resin, and the conductor strands may be made of high damping metal.

### LIST OF REFERENCE SIGNS

1 . . . connector
10 . . . connector housing
11 . . . female terminal (first conductive member)
21 . . . L-shaped terminal (second conductive member)
31 . . . braided wire
32 . . . conductor strand
33 . . . high attenuation strand
90 . . . device

1. A connector to be connected to a device installed in a vehicle, comprising:
a connector housing connectable to a mating connector;
a first conductive member and a second conductive member accommodated inside the connector housing and made of a conductive material; and
a braided wire formed by braiding strands, the braided wire connecting the first conductive member and the second conductive member;
wherein:
the strands include conductor strands made of a conductive material and high attenuation strands made of a high damping material and configured to reduce resonance of the braided wire due to vibration of the vehicle; and
the high damping material is a rubber, a resin or a high damping metal.

2. (canceled)

3. The connector of claim 1, wherein the high damping material is the high damping metal and is selected from the group consisting of a damping alloy or a steel material.

4. A connector to be connected to a device installed in a vehicle, comprising:
a connector housing connectable to a mating connector;
a first conductive member and a second conductive member accommodated inside the connector housing, the first conductive member and the second conductive member being made of a conductive material; and
a braided wire connecting the first conductive member and the second conductive member, the braided wire being formed by braiding conductor strands made of a conductive material and high attenuation strands made of a high damping material selected from the group consisting a rubber and a resin.
